(19) United States
(12) Patent Application Publication
(10) Pub. No.: US 2006/0278453 A1
(43) Pub. Date: Dec. 14, 2006

(54) Arrangement for electrically connecting a magnesium support structure to the ground potential of a motor vehicle

(75) Inventors: Winfried Moll, Laubach (DE); Thomas Vorberg, Goldbach (DE)

Correspondence Address: COHEN, PONTANI, LIEBERMAN & PAVANE, 551 FIFTH AVENUE, SUITE 1210, NEW YORK, NY, 10176, US

(73) Assignee: Siemens Aktiengesellschaft

(21) Appl. No.: 11/439,745

(22) Filed: May 24, 2006

(30) Foreign Application Priority Data
May 27, 2005 (DE) 10 2005 024 383.5

(51) Int. Cl. B62D 25/14

(52) U.S. Cl. 180/90

(57) ABSTRACT

An arrangement in a motor vehicle includes a support structure which is made of magnesium or of a magnesium alloy and includes at least one solid portion. Further, the arrangement includes an electronic component which is supported or held by the support structure, and a connection arrangement having a connection element which is at a prespecified electrical potential. At least one self-tapping screw is self-tapped into the solid portion of the support structure and thereby mechanically connects the support structure to the connection arrangement.

### BACKGROUND OF THE INVENTION

The invention relates to an arrangement in a motor vehicle, having a support structure which is made of magnesium or a magnesium alloy, an electronic component which is supported or held by the support structure, at least one screw and a connection arrangement which is at a prespecified electrical potential, in particular ground potential, wherein the support structure is mechanically connected to the connection arrangement by means of the screw.

A magnesium support structure for a motor vehicle is known from DE 103 17 900 A1, for example, with the support structure being used to mechanically support an instrument panel unit in the cockpit of the motor vehicle. The support structure is designed as a single structural element in the manner of a skeleton and provides additional reinforcement for the vehicle body.

U.S. Pat. No. 6,669,273 likewise discloses a vehicle cross member structure which is made of magnesium and serves to support an instrument panel assembly in the cockpit region of a motor vehicle. The vehicle cross member structure is rigidly connected to the body of the vehicle by means of welded parts or screws. Recesses which contain substrates populated with electronic components on both sides are made in the vehicle cross member structure. The substrates are electrically connected to one another and/or to other parts of the vehicle by means of flat wires. In addition to its function as a mechanical holder for populated substrates, the recess is also used as an electromagnetic shield for the electronics which it contains.

In order to improve the shielding effect of an electrically conductive cover, it is generally known to connect the cover to ground potential. However, such an improvement in the shielding effect of the support structure is not proposed in U.S. Pat. No. 6,669,273, which is why the document also fails to mention a more specific refinement of such a ground connection.

### SUMMARY OF THE INVENTION

The object of the present invention is to improve the shielding effect of a magnesium support structure.

The invention is based on the knowledge that magnesium has a higher negative potential value than most of the other metals, such as aluminum, tin, iron and copper, in the electrochemical potential series. Magnesium is therefore baser than these metals and accordingly has a greater tendency to corrode. If a contact point between magnesium and another metal comes into contact with an electrolyte, for example air containing sulfur, as can be found in urban and industrial areas, or liquid containing ions, so-called contact corrosion occurs, and this leads to the contact point no longer being sufficiently electrically conductive after a certain period of time.

An arrangement, in which a support structure is mechanically connected to a connection arrangement, which is at an electrical potential, in particular ground potential, by means of a screw, is also used to electrically conductively connect the support structure and the connection arrangement in the first moment after the mechanical connection is established. However, the incipient contact corrosion impairs the electrical connection little by little and eventually completely prevents it.

In order to avoid contact corrosion, the mechanical connection between the support structure and the connection arrangement is established by means of a self-tapping screw, with the screw being screwed directly into a solid material portion of the support structure. The screw is therefore not inserted into a predrilled opening or into a pre-cut thread, as is generally customary, but instead taps directly into the magnesium material and establishes an air- and gas-tight connection with the latter. Since the ambient air which acts as an electrolyte no longer reaches the contact region between the screw and the magnesium material, in particular inside the support structure, the electrically conducting connection between the support structure and the connection arrangement by means of the screw can be fully guaranteed. The electromagnetic shielding of the electronic component which is supported or accommodated by the support structure is therefore permanently improved. No further components, such as washers, are required in addition to the self-tapping screw and the screw does not need to be specially coated either, that is to say outlay on material is kept as low as possible. Production costs are also reduced on account of the fact that the operating step of producing a thread or an opening for the screw is no longer necessary.

In one preferred embodiment of the invention, the screw is composed of a metal or a metal alloy whose electrochemical potential has only a low potential difference compared to the electrochemical potential of the support structure. The tendency to corrode can therefore be reduced further since a low potential difference between two materials leads to little electron exchange at the contact point of these materials, which is the cause of contact corrosion.

A connection element which forms part of the connection arrangement is preferably a constituent part of a body of the motor vehicle, that is to say the connection element is therefore connected directly to the electrical ground potential of the body. Examples of the constituent parts of the body include the -pillars, the center hump or the cowl, to which the support structure can be mechanically and at the same time electrically connected.

In one preferred embodiment of the invention, provision is made for the support structure to be connected to an electrically conductive connecting element by means of the self-tapping screw, and for the connecting element to make electrical contact with the connection element. In this way, the support structure can be electrically connected at particularly suitable points. Therefore, in some circumstances, the connecting points on the connection element which are of interest in mechanical terms are not simultaneously suitable for good electrical connection since, for example, a coat or paint which reduces electrical conductivity may be present. A connecting element allows the electrical connection to the support structure to be designed more freely in a three-dimensional manner as the connecting element extends from the points on the connection element which ensure particularly low contact resistance to the support structure.

The connection of a magnesium support structure to a prespecified potential, in particular ground potential, therefore increases the electromagnetic shielding effect for the electronic component which is supported or held by the support structure. In U.S. Pat. No. 6,669,273, flat ribbon cables which are attached to the support structure are used to supply electrical power and electronic data to the electronic component. However, a considerable amount of electromagnetic energy is also emitted by means of the cable. The flat ribbon cables are not deliberately shielded in U.S. Pat. No. 6,669,273, that is to say mutual interference with the electronics which are arranged on the substrates is not excluded.

This is why a further development of the invention proposes that a longitudinal guide for holding at least one electrical cable be formed in the support structure, with the electrical cable being used to make electrical contact with the electronic component which is supported or held by the support structure. In this case, preferred cables are generally customary single-wire lines rather than flat ribbon cables. On account of the longitudinal guide, which functions as a cable duct, a large part of the at least one electrical cable is surrounded by the support structure, which reduces the emission of electromagnetic energy. Possible radiation of external electromagnetic waves into the cable is likewise reduced.

The longitudinal guide preferably has a U-shaped cross section, that is to say it is closed on three sides and open on the fourth side. In this case, the open side should point away from the electronic component or components which is/are supported by the support structure, in order to protect it/them against electromagnetic irradiation and external electromagnetic radiation in an even more effective manner. The at least one cable can be reached easily via the open side, so that easy access for laying cables or repair work is possible.

If a plurality of cables are routed in the longitudinal guide, a secondary embodiment makes provision for at least one of the cables to be a ground cable. Crosstalk, that is to say interfering influences between the cables which are jointly laid in the longitudinal guide, can be reduced in this way.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

The invention is explained in greater detail below with reference to an exemplary embodiment and the drawing, in which

FIG. 1 is an exploded perspective view which shows a support structure and a cable harness which is to be laid in the support structure;

FIG. 2 is a schematic diagram which shows a connection between the support structure and a connection element;

FIG. 3 is a schematic diagram which shows a longitudinal guide for the cable harness, which longitudinal guide is formed on the support structure of FIG. 1; and

FIG. 4 is a cross sectional view through the longitudinal guide of FIG. 3.

### DETAILED DESCRIPTION OF THE PRESENTLY PREFERRED EMBODIMENTS

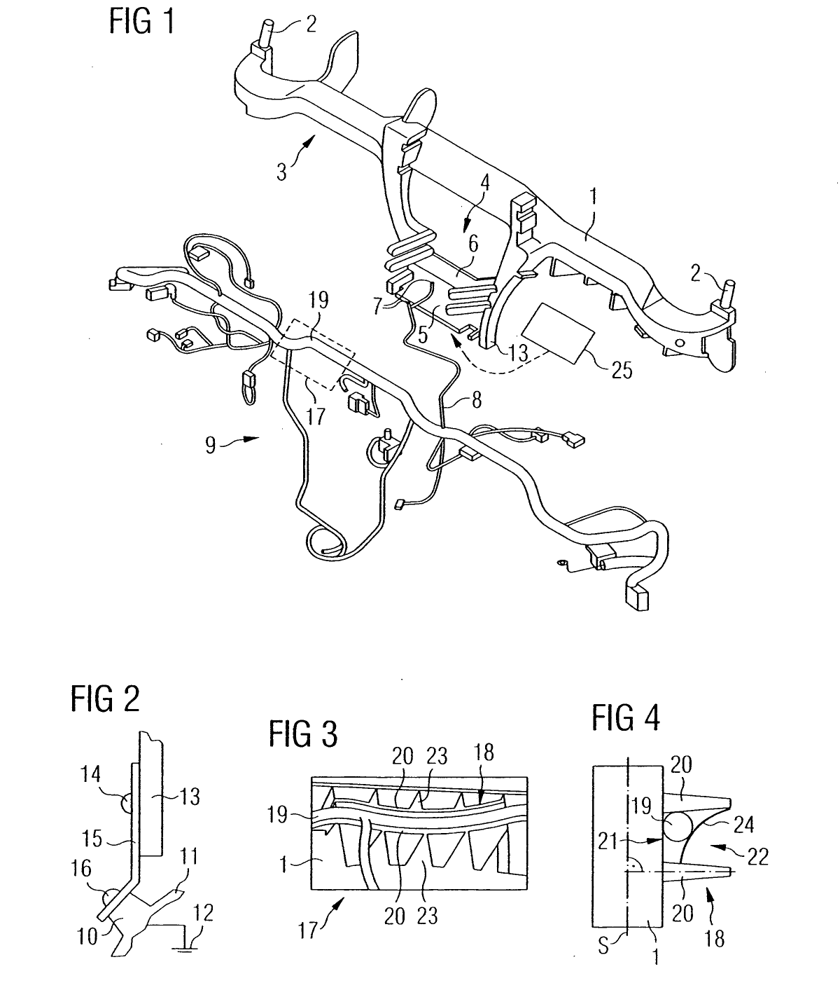

FIG. 1 shows a support structure 1 which is made of a magnesium alloy and is fastened to the A-pillars of a motor vehicle by its transverse ends 2. The support structure 1 is used to hold and mechanically support the electronic modules which are accommodated in the cockpit region of the motor vehicle. For example, a combination instrument is arranged in the left-hand region 3 of the support structure, and a multimedia instrument is arranged in the middle region 4. The middle region 4 of the support structure has a shelf 5 which is integrally formed with the support structure 1 and on which a rear wall 6, which is likewise part of the support structure 1, is integrally formed. An electronic component 25, which is part of the multimedia instrument and is, for example, a populated printed circuit board, is fastened on the shelf 5 and supplied with electrical power and electronic information signals by means of the plugs 7. The plugs 7 are located at the ends of a plurality of cables 8 which form a kind of partial cable harness which, in turn, is a constituent part of a cable harness 9. When in the installed state in the motor vehicle, the cable harness 9 is laid along the support structure 1 and comprises a large number of individual wire lines.

The shelf 5 and the rear wall 6 ensure that the electronic component 25 which is fastened on the shelf is shielded against external electromagnetic radiation, and prevent the emission of electromagnetic energy in these directions. In order to intensify this shielding effect, the support structure 1 is connected to ground potential.

This ground connection is made by means of the arrangement in FIG. 2. A connection element 10 is integrally formed directly on the steel body 11 of the motor vehicle and the body 11 is connected to the vehicle ground 12. A connecting element 15 which is in the form of a metal sheet and is produced from an electrically conductive material, in particular steel, is fastened to an integrally formed portion 13 on the support structure 1 (see FIG. 1) by means of a self-tapping screw 14 which is composed of metal or a metal alloy. The connecting element 15 is in turn fastened to the connection element 10 by a screw 16. The important factor in this arrangement is that no opening or thread for receiving the self-tapping screw 14 is made in the support structure 1 beforehand, but instead the screw 14 is screwed directly into the solid material of the support structure 1. The screw is composed, for example, of a hard metal such as steel. However, if the mechanical design constraints allow, a softer metal whose potential in the electrochemical potential series is closer to magnesium, that is to say, for example, aluminum and its alloys, would also be suitable. In contrast to the screw 14, the screw 16 for fastening the connecting element 15 to the connection element 10 does not need to be self-tapping since the elements 15 and 10 are both composed of steel and there is therefore no need to worry about contact corrosion.

In the installed state, the cable harness 9 of FIG. 1 is routed along the support structure 1 and fastened to it. The manner of routing is illustrated in greater detail in FIGS. 3 and 4. In this case, FIG. 3 shows an enlargement of the detail 17 of the cable harness 9 in the installed state. A longitudinal guide 18 is formed on the support structure 1 and holds the section 19 of the cable harness 9 which runs in the transverse direction parallel to the support structure 1. The cross section of the support structure 1 with the integrally formed longitudinal guide 18 which is illustrated in FIG. 4 shows that the cross section of the longitudinal guide 18 has a U-shape. The side walls 20 and the rear wall 21 of the longitudinal guide 18 surround the section 19 of the cable harness 9 along its outer circumference from three sides. The fourth side faces in the direction of an opening 22.

In FIG. 3, the longitudinal guide 18 is of slightly rolling or undulating design in the direction of its longitudinal extent and the side walls 20 are supported at uniform intervals by ribs 23 which are likewise formed on the support structure 1. In FIG. 3, the side walls 20 are also integrally formed at an acute angle to the perpendicular S of the support structure 1, so that the opening 22 points obliquely upward. The section 19 of the cable harness 9 is therefore already held in the longitudinal guide 18 on account of the force of gravity. In contrast, it is advantageous to provide an elastic fastening element 24 when the side walls 20 and the perpendicular S of the support structure 1 are at right angles to each other, as shown in FIG. 4.

Thus, while there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements which perform substantially the same function in substantially the same way to achieve the same results are within the scope of the invention. Moreover, it should be recognized that structures and/or elements shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

What is claimed is:

1. An arrangement in a motor vehicle, comprising
a support structure which is made of magnesium or of a magnesium alloy and comprises at least one solid portion;
an electronic component supported or held by said support structure;
a connection arrangement having a connection element which is at a ground potential; and
at least one self-tapping screw self-tapped directly into said at least one solid portion of said support structure and mechanically connecting said support structure to said connection arrangement.

2. The arrangement of claim 1, wherein said screw is composed of a metal or a metal alloy having an electrochemical potential that is closer than an electrochemical potential of steel to an electrochemical potential of said support structure.

3. The arrangement of claim 1, wherein said connection element is a constituent part of a body of the motor vehicle.

4. The arrangement of claim 1, wherein said connection arrangement further comprises an electrically conductive connecting element, which is connected to said support structure by said self-tapping screw and is in electrical contact with said connection element.

5. The arrangement of claim 1, further comprising at least one electrical cable to make electrical contact with said electronic component which is supported by said support structure, wherein said support structure comprises a longitudinal guide for holding said at least one electrical cable.

6. The arrangement of claim 5, wherein said longitudinal guide has a U-shaped cross section.

7. The arrangement of claim 5, wherein said longitudinal guide accommodates a cable harness comprising a plurality of electrical cables, at least one of said electrical cables being a ground cable.
